(19) United States
(12) Patent Application Publication
(10) Pub. No.: US 2013/0308311 A1
(43) Pub. Date: Nov. 21, 2013

(54) OPTICAL ASSEMBLY AND METHOD FOR USING THE SAME

(71) Applicant: DELTA ELECTRONICS, INC., Taoyuan Hsien (TW)

(72) Inventors: Mao Shan HSU, Taoyuan Hsien (TW); Kuo Tung WU, Taoyuan Hsien (TW); Wen Yueh LIN, Taoyuan Hsien (TW)

(73) Assignee: DELTA ELECTRONICS, INC., Taoyuan Hsien (TW)

(21) Appl. No.: 13/708,602

(22) Filed: Dec. 7, 2012

(30) Foreign Application Priority Data
May 21, 2012 (TW) 101117934

(51) Int. Cl. F21V 5/04

(52) U.S. Cl. CPC F21V 5/04
USPC 362/235

(57) ABSTRACT

An optical assembly for an illumination system and a method for using the optical assembly are provided. The illumination system comprises a plurality of laser light sources. The optical assembly comprises a carrier and a lens. The lens is assembled to a partial periphery of a bore of the carrier. The lens is positioned in the optical path of one of the laser light source by using the carrier to move the lens so that the lens is disposed above the laser light source correspondingly.

This application claims priority to Taiwan Patent Application No. 101117934 filed May 21, 2012, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention provides an optical assembly and a method for using the optical assembly, and more particularly, to an optical assembly for a laser light source and a method for using the optical assembly.

2. Descriptions of the Related Art

Early projectors that use white light bulbs as the main light sources not only have bulky volumes but also generate high heat during operation, which tends to damage the projectors. With the development of technologies, laser light sources that are currently available can generate a stable light with a high intensity and have advantages of a broad color gamut and bright colors; and therefore, laser light sources have gradually replaced conventional bulbs. Laser light sources can not only effectively reduce the volume of the projectors but also generate vivid images, so laser light sources are commonly used in projectors.

FIG. 1A shows a schematic exploded view of a prior art laser light source device 1. The laser light source device 1 comprises a plurality of optical lenses 11, a lens substrate 12, a plurality of laser light sources 13 and a light source base 14. In order for the laser light source device 1 to provide an adequate brightness, the laser light sources 13 are firstly arranged on the light source base 14.

Because laser light sources 13 need to be further processed by optical lenses before becoming effective light sources necessary for subsequent projection images, the laser light source device 1 of the prior art must use the lens substrate 12 to carry the optical lenses 11. As shown in FIG. 1A, the lens substrate 12 has a plurality of openings 121 formed therein for accommodating the laser light sources 13, and has a dented bearing portion 122 pre-formed around each of the openings 121 and on the surface 12a of the lens substrate 12. Moreover, the bearing portion 122 has exactly the same size as each of the optical lenses 11, so the optical lenses 11 can be fixed on the bearing portions 122 directly and disposed above the laser light sources 13.

However, if the optical lenses 11 and the laser light sources 13 cooperate with each other optimally to achieve the optimal light processing effect, a calibrating instrument is further used to calibrate the position of the optical lenses 11. As shown in FIG. 1B, although the bearing portions 122 on which the optical lenses 11 are positioned are designed on the lens substrate 12 in advance according to an optical path of the optical lenses 11 and the laser light sources 13, deviations may still exist between the position of the optical lenses 11 and the optical path of the laser light sources 13. However, in this case, it is impossible to finely adjust the optical lenses 11 in the laser light source device 1 of the prior art, so the light processing effect of the optical lenses 11 and the laser light sources 13 cannot be improved effectively, which affects the optical quality of the projector.

In view of this, it is important to provide an optical assembly for an illumination system, which allows the calibration of the position of the optical lenses in such a way that the optimal optical conversion effect can be obtained for the optical lenses and the laser light sources to improve the illuminating quality of the overall illumination system.

### SUMMARY OF THE INVENTION

An objective of the present invention is to provide an optical assembly for an illumination system, and more particularly, an optical assembly for a laser light source, in which the optimal optical quality is obtained for the illumination system by means of a carrier of the optical assembly. To achieve the aforesaid objective, the illumination system of the present invention comprises a plurality of laser light sources, while the optical assembly comprises a carrier and a lens. The lens is assembled to the partial periphery of a bore of the carrier. The lens is positioned in the optical path of one of the laser light sources by using the carrier to move the lens partially so that the lens is disposed above the laser light source correspondingly.

Another objective of the present invention is to provide a method for using an optical assembly, which accurately adjusts the optical position of a lens by using a carrier so that the optical position of the lens and the optical path of a laser light source can lead to the optimal optical conversion effect and the optimal optical quality can be obtained for an illumination system. To achieve the aforesaid objective, the method for using the optical assembly of the present invention comprises the following steps: fastening a lens to a carrier, wherein the lens is assembled to the partial periphery of a bore of the carrier; and moving the lens partially by using the carrier so that the lens is both positioned in the optical path of one of the laser light sources and disposed above the laser light source correspondingly.

By using a machine to clamp the carrier of the optical assembly, the present invention can prevent the machine from directly damaging the lens, and can accurately adjust the position of the lens so that the position of the lens and the optical path of the laser light source lead to an optimal optical conversion effect. Thereby, the optical quality of the illumination system is improved effectively, and the production efficiency of the illumination system is increased.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic exploded view of a laser light source device of the prior art;

FIG. 1B is a schematic view of the laser light source device of the prior art with optical lenses;

FIG. 2A is a schematic exploded view of an illumination system of the present invention;

FIG. 2B to FIG. 2D are schematic views illustrating the use of an optical assembly of the present invention in the illumination system;

FIG. 3 is a schematic enlarged view of the optical assembly of the present invention; and

FIG. 4 is a schematic flowchart diagram of a method for using an optical assembly of the present invention.

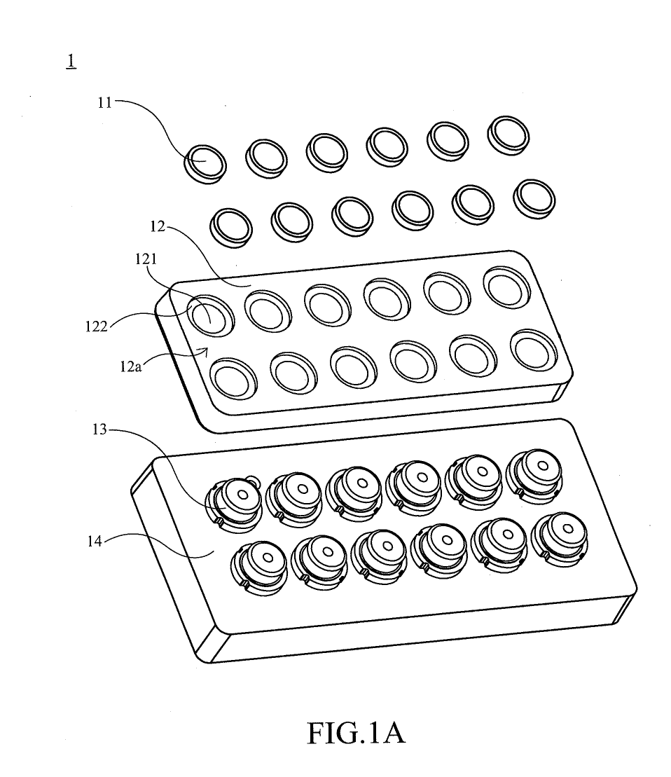

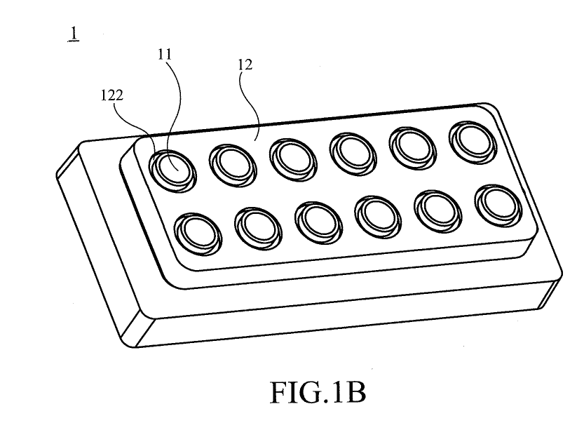

### DESCRIPTION OF THE PREFERRED EMBODIMENT

For convenience of description, the present invention will be explained with reference to embodiments thereof hereinbelow. However, the description of these embodiments is only for the purpose of illustration rather than to limit the present invention. It shall be appreciated that the dimensional and positional relationships among individual elements in the attached drawings are illustrated only for the ease of understanding but not to limit the actual scale and the actual size.

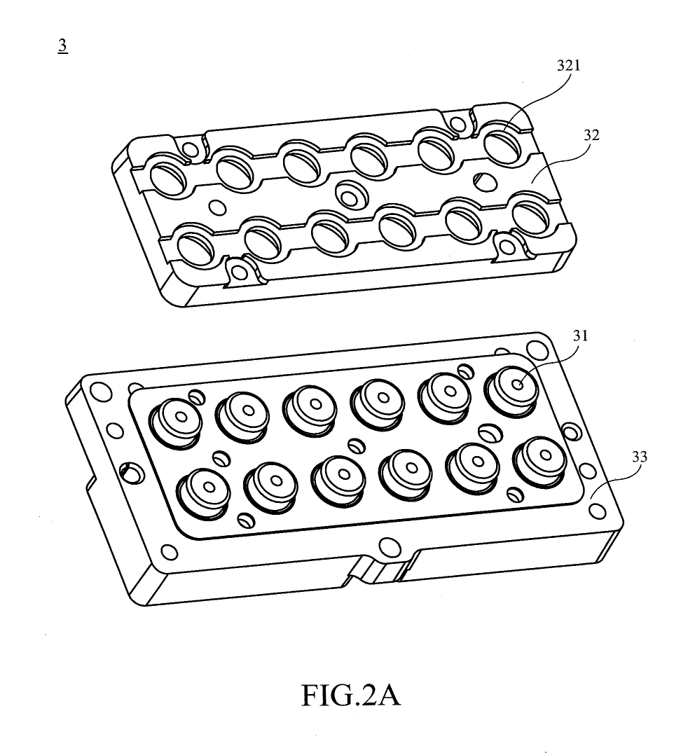

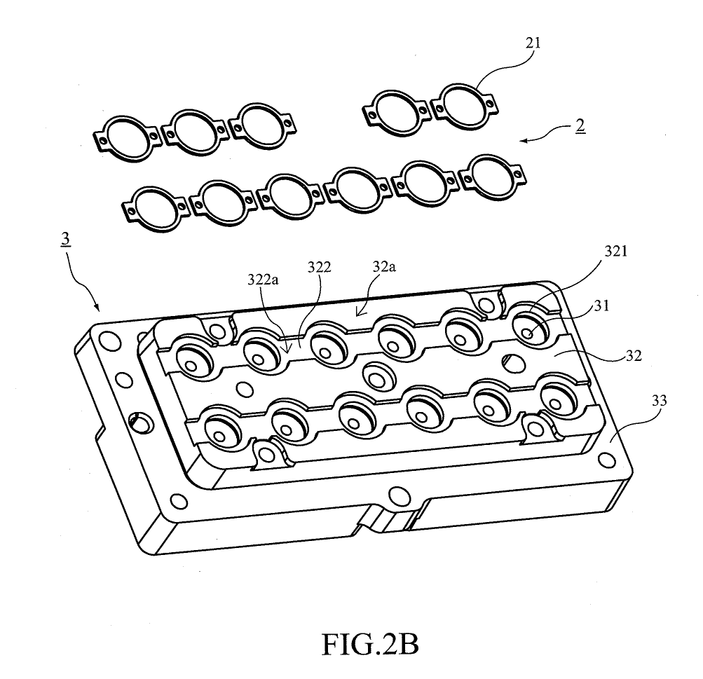

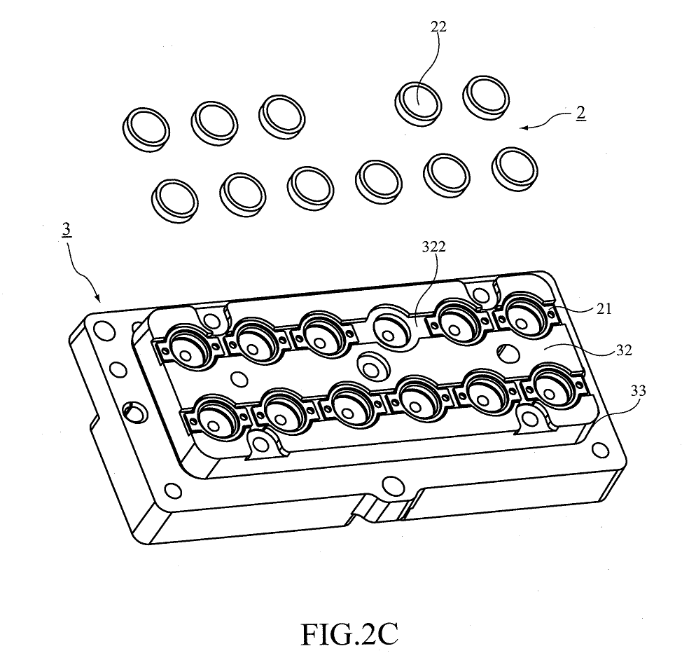

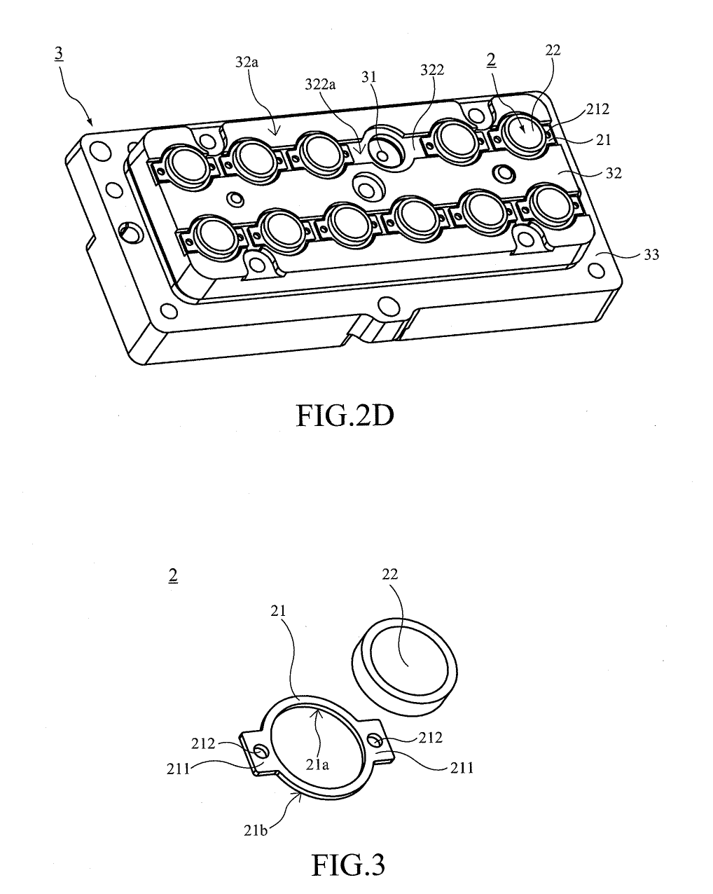

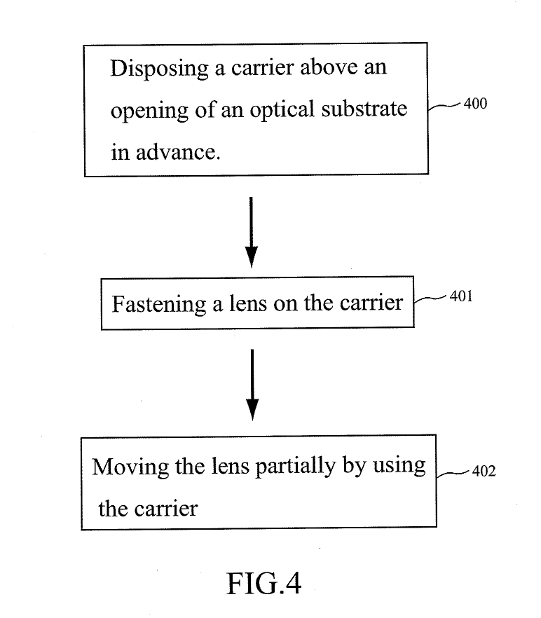

FIG. 2A is a schematic exploded view of an illumination system of the present invention; FIGS. 2B to 2D are schematic views illustrating the use of an optical assembly of the present invention in the illumination system; FIG. 3 is a schematic enlarged view of the optical assembly of the present invention; and FIG. 4 is a schematic flowchart diagram of a method for using an optical assembly.

First, with reference to FIG. 2A, the components and structural relationships of the illumination system 3 will be firstly described herein. The illumination system 3 comprises a plurality of laser light sources 31, an optical substrate 32 and a base body 33. The laser light sources 31 are arranged on the base body 33, and are located below a plurality of openings 321 formed in the optical substrate 32 respectively so that the laser light sources 31 are disposed between the base body 33 and the optical substrate 32. It shall be supplementally described herein that the number and arrangement of the laser light sources 31 of the present invention are not limited to what is shown in FIG. 2A; and instead, a sufficient number of laser light sources 31 may be arranged according to the light intensity actually required, or the laser light sources 31 may be arranged in an array form as shown in FIG. 2A or arranged alternately (which will not be additionally shown herein) according to the need in the optical design.

With reference to FIG. 3, the components and structural relationships of the optical assembly of the present invention will be described. The optical assembly 2 comprises a carrier 21 and a lens 22. The lens 22 is assembled to a partial periphery of a bore 21a of the carrier 21.

It shall be particularly appreciated herein that the common lenses are preferably in a circular form; however, the carrier 21 of the present invention is not merely limited to the annular form shown in FIG. 3, and may be designed into a form adequate to fix the lens 22 according to the actual form of the lens. In other words, the form of the bore 21a of the carrier 21 is determined by the form of the lens 22.

On the other hand, the optical assembly of the present invention can be moved by using an automatic machine. Therefore, as shown in FIG. 3, the carrier 21 of the present invention is further designed to have at least two protrusions 211 formed around the outer periphery 21b of the carrier 21, and each of the protrusions 211 is formed with a through hole 212. Thus, the automatic machine can use a gripper to clamp the through holes 212 of the protrusions 211 to move the optical assembly 2.

The method in which the optical assembly 2 in the illumination system 3 is used will be further detailed now. First, with reference to FIGS. 2B and 4 together, the laser light sources 31 are disposed below the openings 321 of the optical substrate 32 correspondingly. Then, step (400) is executed to dispose the carrier 21 of the optical assembly 2 above one of the openings 321 of the optical substrate 32 in advance. It shall be appreciated that the present invention can use the automatic machine to move the carriers 21 individually and place the carriers 21 onto the optical substrate 32. However, to clearly define the positions of the carriers 21 and prevent the carriers 21 from moving arbitrarily above the openings 321 of the optical substrate 32, the present invention further has a dented portion 322 formed on the upper surface 32a of the optical substrate 32 and around each of the openings 321. The dented portion 322 defines a contact surface 322a. Therefore, the automatic machine can place the carrier 21 directly into the space of the dented portion 322. It shall be noted that the form of the dented portion 322 of the present invention is not limited to what is shown in the present invention, and the size of the dented portion 322 only needs to be slightly larger than that of the carrier 21 as long as there is sufficient space for the carrier 21 to partially move within the dented portion 322.

Next, as shown in FIGS. 2C and 4, because the carrier 21 has been disposed into the dented portion 322 of the optical substrate 32 in advance, step (401) is executed to assemble the lens 22 and the carrier 21 of the optical assembly 2 together. As described above, the lens 22 is assembled to the partial periphery of the bore 21a of the carrier 21. Other assembly relationships between the lens 22 and the carrier 21 are the same as those described above and, thus, will not be further described herein.

Expanding on the above, although the lens 22 of the optical assembly 2 has been disposed above the laser light source 31 correspondingly, the position of the lens 22 and the optical path of the laser light source 31 still cannot provide an optimal light processing effect. Therefore, a calibrating device (not shown) may be used to calibrate the position of the lens 22 and the optical path of the laser light source 31.

Finally, with reference to FIGS. 2D and 4, step (402) is executed to clamp the through holes 212 of the carrier 21 by using the automatic machine again so that the carrier 21 is moved along the contact surface 322a partially and horizontally in the dented portion 322 according to the test result of the calibrating device. In other words, when the carrier 21 is clamped by the automatic machine, the overall optical assembly 2 can be moved and meanwhile, the lens 22 is properly positioned in the optical path of the laser light source 31. Thereby, the optimal light processing effect can be obtained for the illumination system.

As is known by those of ordinary skill in the art, after the position of the lens 22 has been calibrated and determined, an adhesive (not shown) may be dispensed between the frame of the carrier 21 and the dented portion 322 so that the carrier 21 of the optical assembly 2 is fixed onto the optical substrate 32 and the overall optical assembly 2 will not move arbitrarily or disengage from the optical substrate 32.

According to the above descriptions, by using an automatic instrument to clamp the carrier 21 of the optical assembly of the present invention, the position of the lens 22 can be adjusted accurately and finely so that the position of the lens 22 and the optical path of the laser light source 31 lead to an optimal optical conversion effect. Therefore, using the optical assembly of the present invention in the laser light source can not only improve the optical quality of the overall illumination system but also effectively increase the production efficiency of the illumination system.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An optical assembly for an illumination system, the illumination system comprising a plurality of laser light sources, the optical assembly comprising:
a carrier; and
a lens, being assembled to a partial periphery of a bore of the carrier,
wherein the lens is positioned in the optical path of one of the laser light sources by using the carrier to move the lens partially so that the lens is disposed above the laser light source correspondingly.

2. The optical assembly as claimed in claim 1, wherein the illumination system comprises an optical substrate and a base body, and each of the laser light sources is arranged on the base body and correspondingly disposed within a plurality of openings formed in the optical substrate respectively so that the laser light sources are disposed between the base body and the optical substrate.

3. The optical assembly as claimed in claim 2, wherein the carrier and the lens are adapted to be disposed above the opening of the optical substrate.

4. The optical assembly as claimed in claim 2, wherein the optical substrate further comprises a dented portion formed on an upper surface of the optical substrate and around each of the openings, and the dented portion defines a contact surface.

5. The optical assembly as claimed in claim 1, wherein the carrier further has at least two protrusions formed around an outer periphery of the carrier, and each of the protrusions is formed with a through hole.

6. A method for using an optical assembly of an illumination system, the illumination system comprising a plurality of laser light sources, the method for using the optical assembly comprising the following steps:
(401) fastening a lens to a carrier, wherein the lens is assembled to a partial periphery of a bore of the carrier; and
(402) moving the lens partially by using the carrier so that the lens is positioned in the optical path of one of the laser light source so that the lens is disposed above the laser light source correspondingly.

7. The method as claimed in claim 6, wherein the illumination system comprises an optical substrate and a base body, and each of the laser light sources is arranged on the base body and correspondingly disposed within a plurality of openings formed in the optical substrate respectively so that the laser light sources are disposed between the base body and the optical substrate.

8. The method as claimed in claim 7, further comprising a step (400) of disposing the carrier above the opening of the optical substrate in advance before the step (401).

9. The method as claimed in claim 7, wherein the optical substrate further comprises a dented portion formed on an upper surface of the optical substrate and around each of the openings, and in the step (402), the carrier moves along a contact surface of the dented portion partially and horizontally to position the lens in the optical path of one of the laser light sources.

10. The method as claimed in claim 6, wherein the carrier further has at least two protrusions formed around an outer periphery of the carrier, and each of the protrusions is formed with a through hole so that a gripper device can be used to clamp the through hole of the protrusion to move the carrier.
